(19) United States
(12) Patent Application Publication
(10) Pub. No.: US 2002/0149630 A1
(43) Pub. Date: Oct. 17, 2002

(54) Providing hand-written and hand-drawn electronic mail service

(75) Inventors: Leonid M. Kitainik, Cupertino, CA (US); Alexander Pashintsev, Cupertino, CA (US)

Correspondence Address: MERCHANT & GOULD PC, P.O. BOX 2903, MINNEAPOLIS, MN, 55402-0903, US

(73) Assignee: Parascript LLC

(21) Appl. No.: 10/123,733

(22) Filed: Apr. 15, 2002

Related U.S. Application Data
(60) Provisional application No. 60/284,075, filed on Apr. 16, 2001.

(51) Int. Cl. G09G 5/00

(52) U.S. Cl. 345/863

(57) ABSTRACT

A system and method for providing an e-mail service for handling electronic ink input. Text input and drawing input is received from a client as text electronic ink input and drawing electronic ink input. Handwritten characters from the text electronic ink input are recognized and electronic ink text data is generated. Draw tool configuration information based on selections at the client is received and applied to the drawing electronic ink input to generate electronic ink drawing data. An electronic ink display is created based on the electronic ink text data and the electronic ink drawing data. The text input from the client may also include keystroke text input. The keystroke computer readable code is converted into electronic ink text data. In addition, the input from the client may include electronic ink gestures. The electronic ink gestures are interpreted, and based on the interpretation a gesture action is called to operate on the electronic ink display. Further, the input from the client system may also include command input selected with a pointing device such as pen and stylus. The pen command input is detected, and the action required by the command is performed on the electronic ink display. The pen commands are edit commands, space insertion commands, and reshape commands to improve the appearance of the hand drawn shapes.

### RELATED APPLICATIONS

This application claims the benefit of priority of U.S. provisional application Serial No. 60/284,075, filed Apr. 16, 2001.

### FIELD OF THE INVENTION

This invention relates to a computer system and method for communicating using hand-written electronic documents. More particularly the invention relates to providing an e-mail service giving users the ability to use hand written text and freehand drawn sketches.

### BACKGROUND OF THE INVENTION

Pen-enabled input for computing systems particularly mobile computing systems has created a fast growing market for wireless internet appliances. The input of information by the user into these pen and tablet types of wireless communication devises continues to be slow and inefficient. Typically characters of a text message are entered by selecting characters with a pen or stylus on a touch screen display of a keyboard. By tapping each character one can build up a word or a plurality of words to create a message. This technique is quite inefficient when one is trying to generate an e-mail message.

Another technique, one example of which is the GRAFFITI system by 3COM, interprets predefined strokes of a pen on screen as characters and converts these characters to an electronic input or text input for the message. The difficulty with this approach is that it requires the user to learn a stroke language to encode each character that the user wishes to input. Also, the stroke language is relatively unforgiving requiring some precision by the user in generating the stroke so that it will be properly recognized. Further, neither of these techniques allows a user to input hand drawn sketches in the e-mail note being composed.

### SUMMARY OF THE INVENTION

In accordance with this invention, the above problems, and other problems, have been solved by providing an e-mail service for handling electronic ink input for an electronic document. Text input and drawing input is received from a client as text electronic ink input and drawing electronic ink input. Handwritten characters from the text electronic ink input are processed to generate electronic ink text data. Draw tool configuration information based on selections at the client is received and applied to the drawing electronic ink input to generate electronic ink drawing data. An electronic ink document is created based on the electronic ink text data and the electronic ink drawing data.

In another aspect of the invention, the input from the client further includes electronic ink gestures. The electronic ink gestures are interpreted, and based on the interpretation a gesture action is called to operate on the electronic document. Handwritten text input as gesture content may be included with the gesture. The gesture content is also interpreted, and a shortcut action is called to operate on the electronic document.

In another aspect of the invention, input from the client system further includes command input selected with a pointing device such as pen and stylus. The pen command input is detected, and the action required by the command is performed on the electronic document. If the command input is an edit command, the act of performing comprises selecting a portion of the electronic document, and executing the edit action on the portion of the electronic document. If the command input is an insert space command, the act of performing inserts new space in the electronic document. If the command input is a reshape command, the act of performing reshapes hand drawn shapes to improve the appearance of the hand drawn shapes.

In another aspect of the invention, the text input from the client includes keystroke text input. A keystroke computer readable code is detected for each keystroke of keystroke text input. The keystroke computer readable code is converted into electronic ink text data.

These and various other features as well as advantages, which characterize the present invention, will be apparent from a reading of the following detailed description and a review of the associated drawings.

### BRIEF DESCRIPTION OF THE DRAWINGS

FIG. 1 shows the architecture of an e-mail system illustrating a server providing hand written e-mail service to a client.

FIG. 2 shows an exemplary computing system for implementing the server or client.

FIG. 3 shows the operational flow for providing hand written and hand drawn e-mail service.

FIG. 4 shows the operational flow for the gesture/shortcut handling module 206 of FIG. 3.

FIG. 5 shows the operational flow for text input processing module 213 of FIG. 3.

FIG. 6 shows the operational flow for drawing input processing module 215 of FIG. 3.

FIG. 7 shows the operational flow for the pen command processing module 231 of FIG. 3.

FIG. 8 shows the operational flow edit action operation 314 in FIG. 7.

### DETAILED DESCRIPTION OF PREFERRED EMBODIMENTS

Electronic ink is stroke information in the form of sequential X-Y locations occupied by elements or points of the stroke. The stroke is entered by hand with pen or stylus on touch screen or by mouse or similar device controlling a cursor on a computer display screen. The electronic ink may, but need not, include other information such as direction and velocity of stroke, pen pressure, pen lift over the surface, slant of pen, etc. In other words electronic ink is a digital representation of a stroke as a series of X-Y point locations rather than an image representation of black and white picture elements (pels) on a page. The electronic ink representation may be compressed, stored, transmitted and received. The e-mail message written in electronic ink usually appears simply as hand written characters; translation to ASCII or other computer-coded text is optional.

A geometric document is a page defined by its geometrical space rather than the quantity of text lines or number of drawing fields in the document. A geometric document contains geometric elements—text, shapes, lines and pictures. The text is typically handwritten electronic ink text but might also be ASCII text, i.e. computer print text input as keystrokes and processed by the computer as ASCII code. Shapes would typically be freehand drawn shapes entered by stylus or cursor, but might also be computer drawn shapes selected by the pointing device from a standard or reference set of shapes. Lines may be hand drawn or computer drawn; they are usually associated with shapes and might be connecting lines between shapes, dimension lines for shapes or annotation lines connecting text and shapes. Lines might also be independent of shapes as in demarcation lines to separate portions of the document.

Hand drawn shapes or lines are referred to herein as electronic ink drawings or electronic ink drawing data. Finally, pictures are often added to documents now. These pictures might be hand drawn, or they might be pre-existing pictures that have been pasted into the geometric document.

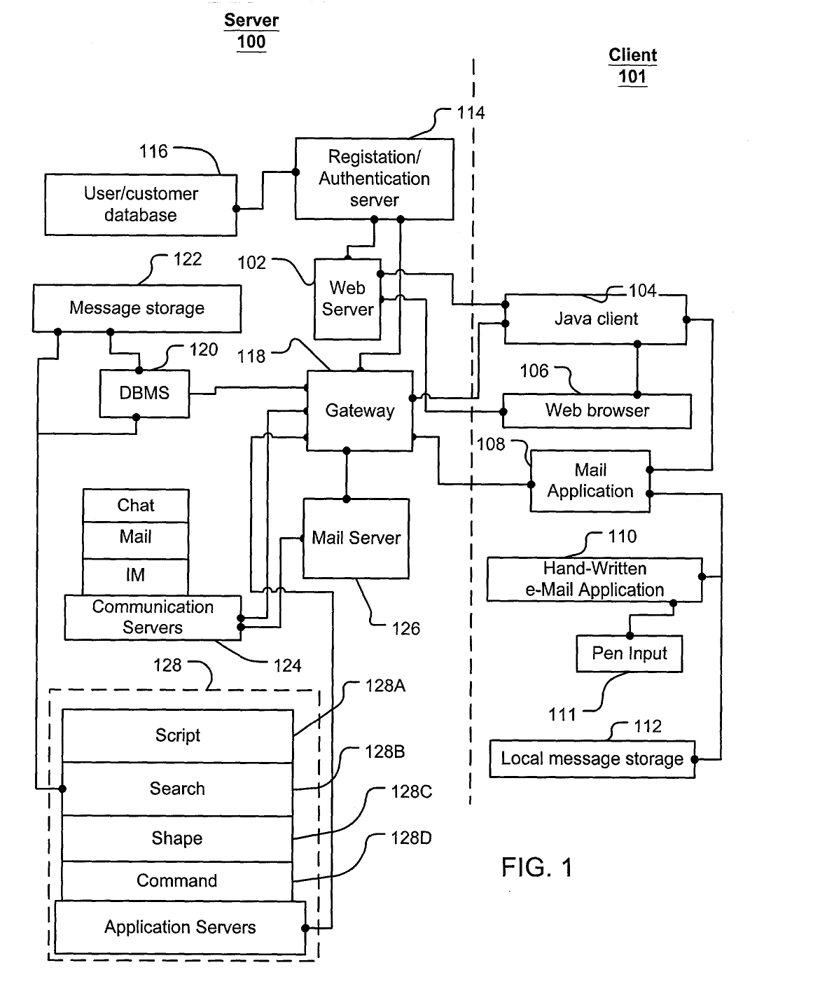

One preferred embodiment of the architecture of the server/client system implementing the invention is shown in FIG. 1. A handwritten e-mail server 100 provides the service to the handwritten e-mail client 101. Web server system 102 operates with client system 104 to oversee the handwritten e-mail operations in this embodiment of the invention. Client system 104 in this embodiment is a Java client system. The operating systems running in the server and client might be a Microsoft Windows system, an IBM OS/2 operating system, a Macintosh Operating System, a Linux system, a Unix system or various other mid-size, scientific and enterprise systems such as AS/400, RS/6000, System 370 from IBM and SOLARIS from Sun Microsystems. For mobile client systems, the operating system might be Palm OS, Pocket PC, Linux, Symbian OS, etc. The client 104 runs a web browser program 106, such as Internet Explorer, NETSCAPE, Communicator and others. For mail clients, the system might run Outlook, Outlook Express, Eudora, NETSCAPE Mail, etc. The handwritten e-mail client application 110 receives the various pen and tablet inputs or cursor inputs 111 and implements the handwritten e-mail operations of the invention at the client through the mail application program 108. Local storage 112 works with the handwritten e-mail application program 110 and the mail application program 108 to store information making up the e-mails handled at the client.

A user at the handwritten e-mail client 101 registers at the handwritten e-mail server 100 for the hand written e-mail service. As shown in FIG. 1, the user runs a JAVA client system 104. The user signs on through the web browser 106 and the web server 102 to the registration/authentication server 114. Registration/authentication server 114 dialogs with the user to collect the information for registration. The user's registration information is stored in the user/customer database 116. Thereafter, the user may sign on and authentication server 114 checks the user against the user information in the database 116. If the user sign on is verified, the user is connected to the handwritten e-mail service. The registration/authentication server 114 compiles and maintains the user customer database 116.

After the client user has been authenticated during each sign on, gateway 118 is enabled and the mail communications pass between the handwritten e-mail client application 110 and the handwritten e-mail server 126 through the gateway 118. The messages through gateway 118 are stored by a data base management system 120 in message storage device 122. The gateway 118 also provides access to communication servers 124 for handling mail and chat services for the electronic mail. These mail and chat services through communication server 124 are provided between mail server 126 to mail client 108 via gateway 118. Also gateway 118 provides access to application servers 128 to provide electronic ink applications such as script processing, command processing, shape processing and searching. Script processing 128A includes handling the electronic ink messages and recognizing the hand written script to convert the script to computer readable text. Searching 128B includes searching for messages or text recognized from the messages by the script processing. Shape processing 128C is also described briefly hereinafter and is described in detail in co pending commonly assigned patent application Ser. No. ______ (Atty. Docket No. 40002.8-US-U3), entitled “Reshaping FreeHand Drawn Lines and Shapes In An Electronic Document” filed concurrently herewith, which is incorporated herein by reference. Command processing 128D includes the processing of handwritten pen commands as will be described hereinafter. The operations of the application servers 128 are preferably performed at the server, and the results in the form of rendered geometric documents are passed back to the client for display to the user. Of course, the application servers or some of their operations could be downloaded to the client and the operations performed directly on the client if the client has sufficient processing power.

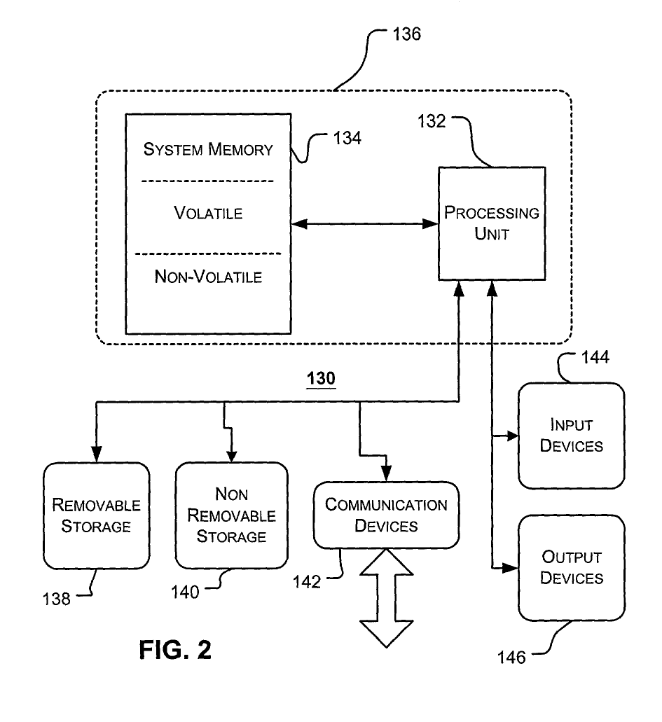

With reference to FIG. 2, an exemplary computing system for implementing the client or server in the system architecture of FIG. 1 includes a computing system, such as computing system 130. In its most basic configuration, computing system 130 typically includes at least one processing unit 132 and memory 134. Depending on the exact configuration and type of computing system, memory 134 may be volatile (such as RAM), non-volatile (such as ROM, flash memory, etc.) or some combination of the two. This most basic configuration is illustrated in FIG. 2 by dashed line 136. Additionally, system 130 may also include additional storage (removable and/or non-removable) including, but not limited to, magnetic or optical disks or tape. Such additional storage is illustrated in FIG. 2 by removable storage 138 and non-removable storage 140. Computer storage media includes volatile and nonvolatile, removable and non-removable media implemented in any method or technology for storage of information such as computer readable instructions, data structures, program modules or other data. Memory 134, removable storage 138 and non-removable storage 140 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by system 130. Any such computer storage media may be part of system 130.

System 130 may also contain communications devices 142 that allow the system to communicate with other systems. Communications devices 142 send and receive communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. The term computer readable media as used herein includes both storage media and communication media.

System 130 may also have input device(s) 144 such as keyboard, mouse, pen, stylus, voice input device, touch input device, etc. Output device(s) 146 include display, speakers, printer, etc. All these devices are well known in the art and need not be discussed at length here.

The logical operations of the various embodiments of the present invention are implemented (1) as a sequence of computer implemented steps, or acts, or as program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, steps, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

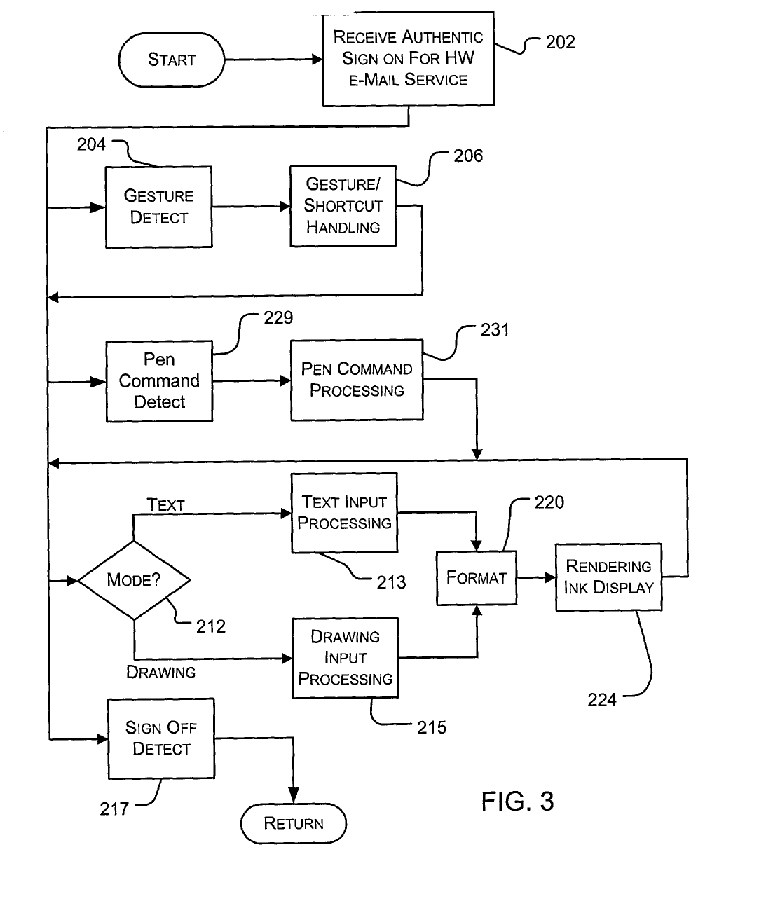

FIG. 3 shows the operational flow for providing handwritten and hand drawn e-mail service from the server to the client for on-line authoring and editing of electronic ink e-mail. The flow begins when the user signs on for handwritten e-mail service and is authenticated as a subscriber or valid user. Receive “sign on” operation 202 receives the authentication or valid user indication. Once the user's sign on is authenticated, the server will begin to process gesture input, command input, and text or drawing input received from the client.

Gesture detect operation 204 checks that a gesture is being input by the predefined movement of the pen or stylus on a display screen at the client. If a gesture is detected the operation flow passes to gesture and shortcut handling module 206. Gestures are specific strokes detected and indicative of a predefined action to be performed or a shortcut selection of an action to be preformed. The gesture may have content with it. The action may be an operation on the geometric document or it may be a call to a macro or even a call to another program. Also, a gesture itself without gesture content may be interpreted by module 206 as an action request. For example, a carriage return shaped gesture (i.e. right angle line down and left) could signal start of new paragraph.

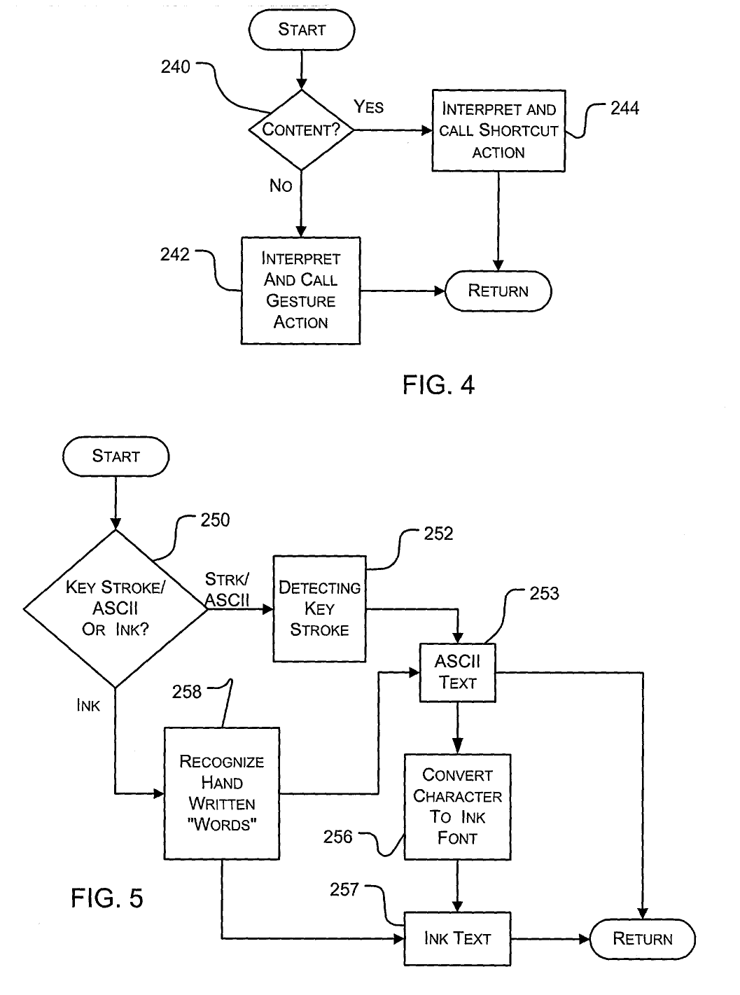

Examples of gestures with content are hand written text surrounded by hand drawn shape such as a circle, handwritten text with a slash and underline, or handwritten text preceded by a check mark. The gesture might precede or succeed the content and be any predefined stroke or shape. A hand drawn “@” might signal entry of a predefined e-mail address. If there is gesture content with the gesture, the hand written content associated with the gesture is interpreted by gesture handling module 206 and action is taken by module 206. Some examples of content interpretation might be “sign” preceded by a check mark which would be interpreted as request for an action to insert a predefined signature at the location of the check mark. A color surrounded by hand drawn shape such as a rectangle would produce a change to that color for the writing tool or draw tool as it makes entries in the geometric document. A program name surround by a shape would be a gesture that would call up that program. For example, “WORD” surrounded by a circle would open the Microsoft WORD computer program. Also styles could be predefined and could be called up by S1, S2 or Sn surrounded by a shape. Style S1 might be ink pen, blue, medium width. Style S2 might be pencil, red, thin width. It will be apparent that many such gestures and shortcuts could be defined and called into action. The gesture handling operation will be described in more detail hereinafter with reference to FIG. 4. Once the gesture is recognized and interpreted, and an action identified with the interpretation is called and performed, the operation flow returns to wait for the next gesture, command or text/drawing mode input.

Because the user's message to be input may be either text or drawing input, the mode query operation 212 detects what type of e-mail message content is being input. If the user input received from the client system is text, the operational flow branches to text processing module 213. If the input from the client is freehand drawing input, the operation flow branches to drawing input processing module 215. Mode query operation may detect the mode by detecting a selection from the user or by detecting the type of information being input. For example if the user is keying strokes or hand writing script, the input is text. On the other hand, the user may use the pen to select a text input button or a drawing input button on the display to indicate the input mode.

Text processing module 213 receives text input in the form of keystrokes from keyboard input to the client computer, or it receives text in the form of handwritten characters written as electronic ink text input using a pointing device such as a pen, a stylus or cursor pointing device writing characters on the computer display. If the input is text, text input processing module detects whether the input is keystrokes or electronic ink text input. If keystrokes are detected, the text may be processed as computer readable text, such as ASCII code, and then formatted and output as computer generated text to rendering operation 224. If hand written electronic ink input is detected, the hand writing is recognized using script application 128A (FIG. 1) and usually converted to ASCII characters. Again the ASCII coded characters could be formatted and output as computer generated text to rendering operation 224. However the preferred text output is electronic ink text data since the user is working with a geometric document. Therefore, the ASCII characters from either the keystrokes or the hand written text recognition are converted to an electronic ink text made up of character strokes. This electronic ink text is formatted by format operation 220 according to selected format parameters. The formatted ink text is output to the rendering operation as electronic ink text data to be rendered and displayed to the user. The text input processing module 213 is described in more detail hereinafter with reference to FIG. 5.

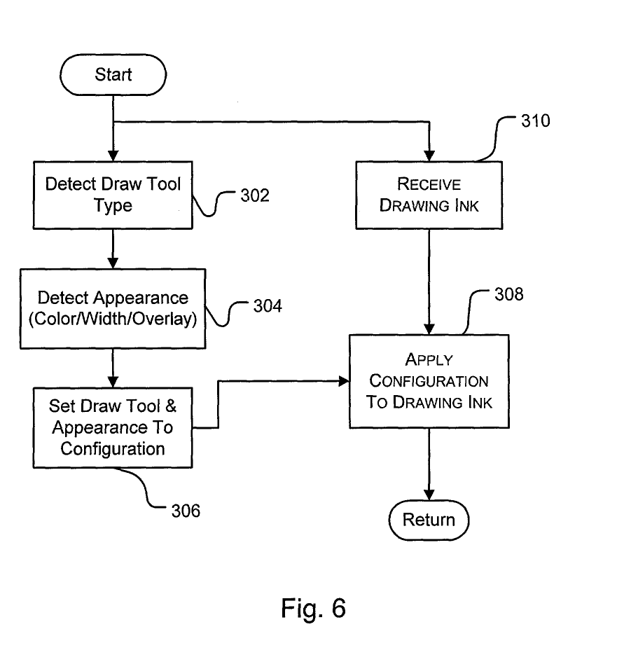

Drawing input processing module 215, processes drawing electronic ink input received from the client system. Drawing input processing module 215 requires two pieces of information to be able to generate electronic ink drawing data. The two pieces of information are the electronic ink input data plus the style information. The electronic ink input is described above. The style information includes draw tool information indicating whether the stroke is to be displayed as drawn by draw tools such as pencil, ink pen, brush, air brush, etc. The style information also includes color and width of line information. The style information is chosen by the user. The drawing input processing module 215 detects the style information along with the electronic ink input data. Module 215 applies the style to the electronic ink input data and generates the electronic ink drawing data. The ink drawing data is formatted by format operation 220 and passed to the rendering operation 224. Rendering operation 224 responds to the formatted electronic ink drawing data and creates the drawing electronic ink display that is passed to the client computer display screen. When the rendering operation is complete, or while it is being processed in the background, the operation flow returns to wait for another gesture, command or text/drawing mode input. The drawing input processing module 215 is described in more detail hereinafter with reference to FIG. 6.

In addition to using gestures to call up programs or actions to operate on the geometric document, the user may also use the pen or stylus to select commands. The presence of a pen command chosen by the user is detected by pen command detect operation 229. If a pen command is detected, the operation flow proceeds to pen command processing module 231. Pen command operations include operations such as editing, inserting space in the geometric document, reshaping hand drawn shapes or objects and other command operations associated with document processing and electronic mail. The pen command processing module 231 is described hereinafter in reference to FIG. 6. Briefly, module 231 detects the command selected by the user and performs the action required by the command with some additional input from the client in some instances. Once the pen command processing is complete or is operating in the background, the operation flow returns to await the next gesture, command or text/drawing mode input.

If the user at the client station has completed the handwritten e-mail input desired, the user will sign off from the handwritten e-mail service. In this event sign off detect operation 217 detects receipt of the sign off input at the server and returns the operation flow in the server to the main program.

Referring now to FIG. 4, the gesture handling module 206 of FIG. 3 is shown in more detail. If a gesture is detected by gesture detect operation 204 (FIG. 3), the operational flow passes to content test operation 240 in FIG. 4 to detect the presence of handwritten content with the gesture. If there is no content with the gesture, the gesture alone is interpreted as a command. The operation flow branches NO from content test operation 240 to interpret gesture operation 242. Interpret gesture operation 242 interprets the gesture, and calls the command action associated with the gesture. The gesture might be interpreted by comparing the gesture to strokes in a reference table that associates the gesture strokes with a command. The called command action for the gesture is executed, and the operation flow returns to wait for the next input in FIG. 3.

If there is content with the gesture, the operation flow branches YES from content test operation 240 to shortcut interpret operation 244. Shortcut interpret operation 244 using script application 128A (FIG. 1) recognizes and interprets the hand written content associated with the gesture as a call for a macro operation or a call to load another program or routine as described above. Once the content is recognized and interpreted, the macro operation, program or routine identified by the interpretation is called by shortcut interpret operation 244. The macro operation or routine is executed or the called program is loaded, and the operation flow returns to wait for another input in FIG. 3.

Referring to FIG. 5 one embodiment of the operations of the text input processing module 213 (FIG. 3) is shown in detail. Because the user may wish to input keystrokes as well electronic ink or may wish to copy ASCII text into the document, the keystroke/ink test operation 250 is detecting what type of e-mail text is being input. Keystroke/ASCII or ink test operation 250 is determining whether the text input is (1) a keystroke or ASCII text or (2) electronic ink which might require hand writing recognition. If the text input is keystroke/ASCII, then the operational flow passes to keystroke detection operation 252. If the text is already ASCII, operation 252 passes it through as ASCII text. If the text is keystroke, the stroke is detected. Once the keystroke is detected, it is converted and output as ASCII coded text 253. This ASCII text may be passed to format operation 220 (FIG. 3) to be formatted and passed on to rendering operation 224 (FIG. 3). However, preferably the ASCII text is passed to conversion operation 256. Conversion operation 256 converts the ASCII characters to characters in a electronic ink font. The ink text 257 out of conversion operation 256 is passed to format operation 220 (FIG. 3). The formatted ink text is passed as electronic ink text data to rendering operation 224 (FIG. 3) to create the electronic ink text display to be passed back to the client system.

If the keystroke/ink test operation 250 detects that it is electronic ink input, i.e. handwritten text, the electronic ink input may be passed as ink text 257 or may be processed by being recognized first in recognition operation 258. Recognition operation 258 recognizes the hand written words and may use any number of hand written recognition algorithms. One particular algorithm that is preferred is the algorithm taught in U.S. Pat. No. 5,467,407 entitled Method and Apparatus For Recognizing Cursive Writing From Sequential Input Information. This recognition technique recognizes hand written text as words, phrases or sentences rather than as individual characters. The output of the recognizer is typically ASCII text 253. This ASCII text may be passed to the format operation 220 (FIG. 3) or to the conversion operation 256 and processed out to the rendering operation 224 as ASCII text or ink text as described above. Alternatively, the recognizer might directly produce ink text 257. In this case the ink text would be passed directly to the format operation 220 (FIG. 3).

Referring now to FIG. 6, the drawing input processing module 215 (FIG. 3) is shown in detail. In FIG. 6 the draw tool detect operation 302 selects a draw tool type by interpreting a draw tool type chosen by the user at the client station. Appearance detection operation 304 detects the desired appearance for the electronic ink. Appearance includes color, width and overlay. Overlay might be used to combine colors by drawing on lines on top of each other and selecting a degree of transparency to combine the colors. If the overlay is not transparent or not to be combined, than the overlay would be used to cover or white out previously drawn shapes or lines. Together, the draw tool or pen tool type and the appearance make up a style for the electronic ink input. As discussed above regarding gestures, styles may be predefined and selected by the user.

When working with style selection in the drawing mode and using gestures, the system will have to be able to distinguish between a gesture discussed above and a drawing shape that the user is entering as electronic ink input. One embodiment for distinguishing between gesture and shape dedicates a portion of the geometric document as the location where gestures may be entered. For example, the margin region of a document might be dedicated to gestures. When the user enters in the margin a “Sn” surrounded by a circle, the system knows to interpret this as a style change.

Set operation 306 sets the configuration of the draw tool based on the style information, i.e. the selected draw tool type and the selected appearance as detected in operations 302 and 304. In one embodiment this draw tool configuration information is passed to the rendering operation 224 (FIG. 3) to adjust the rendering of the electronic ink display from the electronic ink drawing data based at the rendering operation. In another embodiment apply operation 308 applies the configuration to the drawing electronic ink input from the receive operation 310. Apply operation thus creates the finished electronic ink drawing data. The rendering operation then simply receives the electronic ink drawing data, and creates and sends the drawing image to the display at the client system.

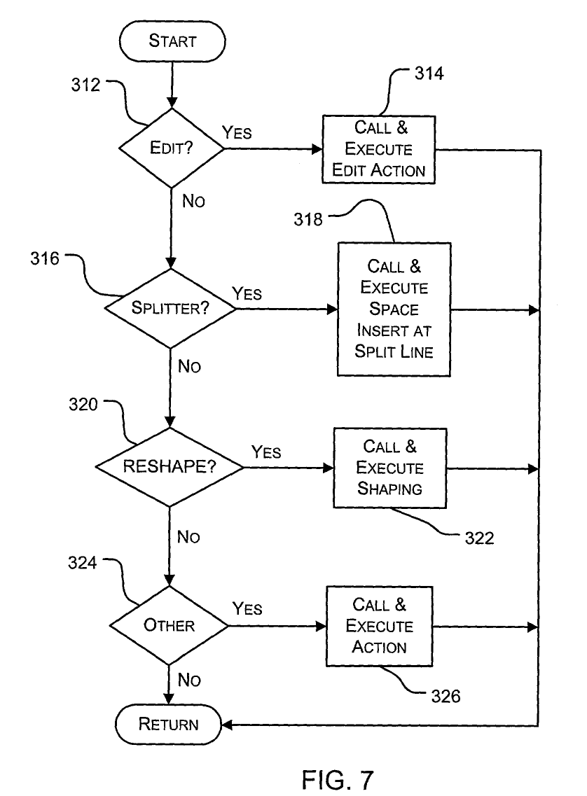

Referring now to FIG. 7, the pen command processing module 231 of FIG. 3 is shown in detail. Pen commands are selected with a pointing device such as a pen or stylus. Pen command module 231 detects the selected command, and thereafter the action associated with the command is called and executed. As depicted in the embodiment of FIG. 7 the command detection for the various commands is performed serially. However it could just as well be performed in parallel.

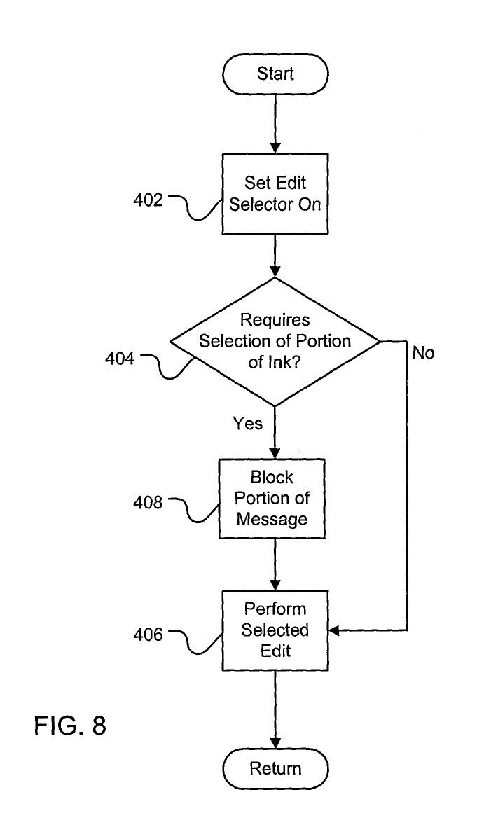

Edit test operation 312 detects an edit command. If an edit command is detected the operation flow branches YES to the edit action operation 314. Operation 314 interprets the edit action desired from the command and calls the edit action to be executed. The edit action operation 314 is described hereinafter in more detail with reference to FIG. 8. If there is no edit action, the operation flow branches NO to splitter test operation 316. Splitter test operation 316 is looking for an insert space command indicating the user wishes to insert new or blank space in the e-mail message. The blank space can then be subsequently written in by using the pen or stylus. If a splitting operation is detected at splitter test operation 316, the operation flow branches YES to the space insertion operation 318. The space insertion operation looks for a user specified split line or a natural break between current electronic ink words and shapes, and inserts space at the split line or break. A detailed description of the splitting operation can be found in co pending, commonly assigned U.S. application Ser. No. ______ (Atty. Docket No. 40002.8-US-U4), entitled Insertion of Space in a Geometric Document, which is incorporated herein by reference.

If a splitting operation is not detected then the operation flow branches NO from splitter test operation 316 to reshape test operation 320. Reshape test operation 320 is detecting a reshape command when the user wishes to improve the shape of common freehand drawn shapes in the e-mail. If reshaping is desired, the operation flow branches YES to reshape operation 322 to recognize the shape and improve it. A detailed description of the reshape operation is described in co-pending commonly assigned U.S. application Ser. No. ______ (Atty. Docket No. 40002.8-US-U3), entitled Reshaping Freehand Drawn Lines and Shapes In An Electronic Document, which is incorporated herein by reference.

If no reshape command is detected, the operation flow passes to other pen command detection operations 324. Other pen commands might be send, reply, reply to all, save, move, delete, etc., i.e. commands associated with e-mail processing. If such a command is detected, the operation flow passes to call and execute operation 326 which executes the command detected in operation 324.

FIG. 8 illustrates in more detail the edit operation 314 of FIG. 7. In FIG. 8 the operation flow begins by setting the edit selector on at set operation 402. Block detect test operation 404 tests whether selection of a block or portion of the electronic ink message is required before performing the edit operation. If blocking is not required, the operation flow branches NO to operation 406 to perform the selected edit operation. If blocking of an edited portion is required for the edit, the operation flow branches YES from test operation 404 to blocking operation 408. Blocking operation 408 marks or identifies a portion of the electronic ink message that is to be edited. After the electronic ink message portion to be edited is blocked, it is then edited in accordance with the selected edit operation 406 that was set by set edit operation 402. Edit operations include cut, copy, paste, bold, underline, delete, erase, drag and other well known edit operations.

While the invention has been particularly shown and described with reference to preferred embodiments thereof, it will be understood by those skilled in the art that various other changes in the form and details may be made therein without departing form the spirit and scope of the invention.

We claim:

1. In an electronic mail service, a method for handling hand written text and freehand drawings as electronic ink input entered into the system with a pointing device used to write and draw on a display screen, the method comprising:
detecting whether input is text or drawing;
processing text input as keystrokes and electronic ink input and generating electronic ink text data;
processing drawing input based on electronic ink input and style information and generating electronic ink drawing data; and
rendering an electronic ink message from the electronic ink text data and electronic ink drawing data on a computer display.

2. The method of claim 1 further comprising:
detecting a selected command selected with the pointing device;
calling an action associated with the command and executing the command on the electronic ink message.

3. The method of claim 2 wherein the selected command is a splitter command and the act of calling and executing comprises:
inserting new text in the geometric document at a split line drawn with the pointing device.

4. The method of claim 2 wherein the selected command is an edit command and the act of calling and executing comprises:
detecting selected portion of message; and
performing selected edit action on selected portion.

5. The method of claim 2 further comprising
detecting a predefined gesture drawn by the pointing device;
handling the predefined gesture to interpret an action associated with the gesture and execute the action on the message.

6. The method of claim 5 wherein the predefined gesture includes hand written content and the act of handling comprises:
interpreting the hand written content to call a shortcut action and executing the shortcut action on the message.

7. The method of claim 6 wherein the shortcut action is the insertion of predefined text into the message.

8. The method of claim 6 wherein the shortcut action is the changing of style of the message.

9. The method of claim 6 wherein the shortcut action is the loading of a program for use by the client system.

10. A server system for providing handwritten and hand drawn e-mail service to a client system where text input and drawing input received from the client system is electronic ink input and the server system returns to the client system geometric documents based on the client input, the server system comprising:
a text input processing module responsive to text electronic ink input and recognizing handwritten words from the text electronic ink input and generating electronic ink text data;
a drawing input processing module responsive to drawing electronic ink input and style information and applying the style information to the drawing electronic ink input to generate electronic ink drawing data; and
a rendering module responsive to the electronic ink text data and the electronic ink drawing data to create and send an electronic ink display to the client system.

11. The server system of claim 10 wherein input from the client system further includes electronic ink gestures and the system further comprises:
a gesture handling module interpreting electronic ink gestures and calling a gesture action to operate on the geometric document.

12. The server system of claim 11 wherein input from the client system further includes a electronic ink gesture and handwritten text input as gesture content with the gesture, and the gesture handling module further comprises:
a gesture content interpretation module for interpreting the gesture content and calling a shortcut action to operate on the geometric document.

13. The server system of claim 11 wherein input from the client system further includes command input selected with a pointing device, and the system further comprises:
command processing module detecting the command input and performing the action required by the command on the geometric document.

14. The server system of claim 13 wherein the command processing module further comprises:
an edit command module processing edit commands and executing the edit action on the geometric document;
a splitter command module responsive to a splitter command inserting new space in the geometric document; and
a reshape command module responsive to a reshape command reshaping hand drawn shapes to improve the appearance of the hand drawn shapes.

15. The server system of claim 10 wherein text input from the client system includes keystroke text input and the text input processing module further comprises:
a keystroke detecting module detecting keystroke computer readable code for each keystroke;
a converting module converting the keystroke computer readable code into electronic ink text data.

16. The server system of claim 10 wherein the drawing input processing module further comprises:
a set module setting the draw tool configuration based on the style information; and
an apply module applying the draw tool configuration to the drawing electronic ink input to generate the electronic ink drawing data.

17. A method for providing handwritten and hand drawn e-mail service to a client where text input and drawing input received from the client is text electronic ink input and drawing electronic ink input, the method comprising:
recognizing handwritten characters from the text electronic ink input and generating electronic ink text data;
receiving draw tool configuration information and applying the configuration information to the drawing electronic ink input to generate electronic ink drawing data; and
creating an electronic ink display based on the electronic ink text data and the electronic ink drawing data.

18. The method of claim 17 wherein input from the client further includes electronic ink gestures and the method further comprises:
interpreting electronic ink gestures and calling a gesture action to operate on the electronic ink display.

19. The method of claim 18 wherein input from the client further includes a electronic ink gesture and handwritten text input as gesture content with the gesture, and the method further comprises:
interpreting the gesture content and calling a shortcut action to operate on the electronic ink display.

20. The method of claim 17 wherein input from the client system further includes command input selected with a pen, and the method further comprises:
detecting the command input; and
performing the action required by the command on the electronic ink display.

21. The method of claim 18 wherein the command input is an edit command and the act of performing comprises:
selecting a portion of the electronic ink display; and
executing the edit action on the portion of the electronic ink display.

22. The method of claim 18 wherein the command input is a splitter command and the act of performing comprises:
inserting new space in the electronic ink display.

23. The method of claim 18 wherein the command input is a reshape command and the act of performing comprises:
reshaping hand drawn shapes to improve the appearance of the hand drawn shapes.

24. The method of claim 17 wherein text input from the client includes keystroke text input and the method further comprises:
detecting keystroke computer readable code for each keystroke of keystroke text input; and
converting the keystroke computer readable code into electronic ink text data.

25. In a server system, apparatus for providing handwritten and hand drawn e-mail service to a client system having a display screen and pen input where text input and drawing input received from the client system is text electronic ink input and drawing electronic ink input, the apparatus comprising:
means for recognizing handwritten characters from the text electronic ink input and generating electronic ink text data;
means for receiving draw tool configuration information from pen input at the client system and applying the configuration information to the drawing electronic ink input to generate electronic ink drawing data; and
means for creating an electronic ink display based on the electronic ink text data and the electronic ink drawing data and sending the electronic ink display to display screen at the client system.

26. The apparatus of claim 25 wherein pen input from the client system further includes electronic ink gestures and the apparatus further comprises:
means for interpreting electronic ink gestures and calling a gesture action to operate on the electronic ink display.

27. The apparatus of claim 25 wherein pen input from the client system further includes pen command input, and the apparatus further comprises:
means for detecting the pen command input; and
means for performing the action required by the pen command on the electronic ink display.

28. The apparatus of claim 25 wherein text input from the client system includes keystroke text input and the apparatus further comprises:
means for detecting keystroke computer readable code for each keystroke of keystroke text input; and
means for converting the keystroke computer readable code into electronic ink text data.
